(19) United States
(12) Patent Application Publication
(10) Pub. No.: US 2006/0112510 A1
(43) Pub. Date: Jun. 1, 2006

(54) Wiper system for a vehicle

(75) Inventor: Bruno Egner-Walter, Heilbronn (DE)

Correspondence Address: MATTHEW R. JENKINS, ESQ., 2310 FAR HILLS BUILDING, DAYTON, OH, 45419, US

(73) Assignee: Valeo Systemes D'Essuyage

(21) Appl. No.: 10/539,186

(22) PCT Filed: Dec. 15, 2003
(86) PCT No.: PCT/EP03/14238

§ 371 Date: Jun. 16, 2005

(30) Foreign Application Priority Data
Dec. 19, 2002 (DE) 102 59 562.3

(51) Int. Cl. B60S 1/24; B60S 1/16; B60S 1/28

(52) U.S. Cl. 15/250.27; 15/250.3; 15/250.31

(57) ABSTRACT

A wiper system and a drive unit for a wiper system for a windscreen of a vehicle, in particular of a motor vehicle, is proposed, comprising two simultaneously driven windscreen wipers and comprising a drive rod between a motor and a wiper bearing of a wiper shaft wherein the motor and the drive rod are arranged and designed in such a way that at least a driver-side crank can be provided for driving the wiper shaft which crank in each position is oriented in a direction towards the vehicle centre.

The invention relates to a wiper system and to a drive unit for a wiper system for a windscreen of a vehicle, in particular of a motor vehicle, comprising two simultaneously driven windscreen wipers. More precisely, the invention relates to a specific arrangement of the elements of a vehicle windscreen wiper system.

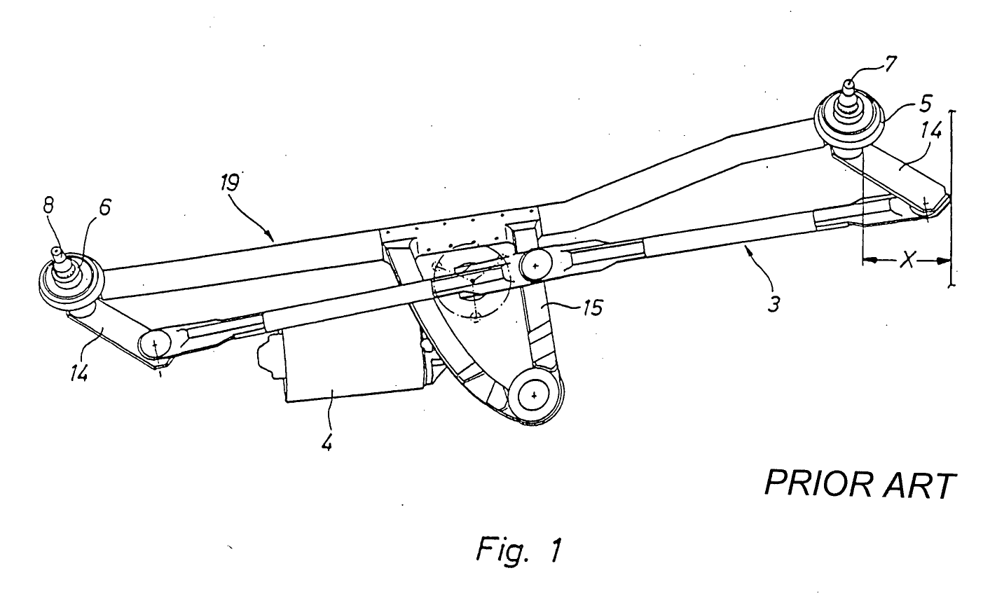

As is known, wiper systems for vehicle windscreens have a drive motor which drives the wiper blades of the windscreen wipers over their respective pivoting radius via a rod which is connected to wiper bearings of the windscreen wipers. Such a known design of conventional wiper systems is shown in plan view in FIG. 1. The wiper system has a motor 4 which is fixed on a retaining plate 15 which is connected to a drive rod 3. The wiper shafts 7, 8 are connected to the retaining plate 15 via a connecting tube 19. The drive moment of the motor 4 is transmitted to the wiper shafts 7, 8 on the wiper bearings 5, 6 via links and deflectors. The driver-side wiper bearing 5 is connected to the rod 3 for example via a deflector 14, wherein the deflector or the deflection element 14 protrudes laterally outwards by an amount X in the parked position of the driver-side windscreen wiper. One disadvantage of this conventional arrangement of a wiper system is that the wiper bearings 5, 6 have to be arranged in such a way that, laterally towards the outside, there must in each case be a region in which deflectors or deflection cranks 14 can move outwards in both directions. As a result, optimal use of the wiping area is prevented since an unwiped area necessarily remains in particular in the region close to the A-column.

It is an object of the present invention to provide a wiper system and a drive unit for a wiper system for a vehicle, in particular for a windscreen of a motor vehicle, which makes it possible to wipe a larger area of the wiping area, in particular in the side regions of a vehicle windscreen. The intention is for as large a wiping area as possible to be cleaned over a given vehicle windscreen.

This object is achieved by a wiper system having the features according to claim 1 and by a drive unit according to claim 12. Advantageous refinements and developments of the invention form the subject matter of the dependent claims.

According to the invention, a wiper system for a windscreen of a vehicle, in particular of a motor vehicle, is provided with a drive rod between a motor and a wiper bearing of a wiper shaft, wherein the motor and the rod are arranged and designed in such a way that a drive crank of the wiper shaft can be provided at least on the driver side in such a way that in each position it is oriented in a direction towards the vehicle centre. The bearing point at least of the driver side can thus be arranged further out than was previously the case. The wiping area is increased.

According to one advantageous refinement, the motor is arranged in front of and at a distance from the wiper bearing in the direction of travel of the vehicle, wherein the drive rod has at least one crank or a lever for driving the wiper shaft, which crank in each position (pivoting position) is oriented in a direction towards the vehicle centre. As a result, the wiper bearing can be arranged closer to the respective vehicle column and in particular the A-column of the vehicle than was previously the case. In this way, it is possible to realize for the wiper an essentially parallel end position from the edge region of the windscreen of a vehicle. As a result, dead areas in which an unwiped or dirty region is left behind after wiping with the windscreen wipers of the vehicle are prevented. This makes it possible, both in wiper systems which operate in opposite directions and in wiper systems which operate in the same direction, to realize an essentially parallel upper end position of each windscreen wiper with respect to the A-column of the motor vehicle. As a result, a larger area of a vehicle windscreen can be cleaned than was previously the case. This is because the respective wiper bearings can be arranged further at the edge region of the vehicle body and thus closer to the respective lateral A-columns of the body.

According to one advantageous refinement of the invention, the motor of the wiper system is connected to a driver-side wiper bearing via the drive rod. As a result, only one of the wiper bearings of the windscreen wiper system of the vehicle must be connected to a rod oriented in the longitudinal direction of the vehicle, that is to say essentially in the direction of travel Y of the vehicle. The space requirement is thus reduced to a minimum.

According to one advantageous refinement of the invention, at least the driver-side wiper bearing is arranged close to an A-column of the vehicle. The region of a vehicle windscreen which is particularly critical for the driver's view is thus cleaned and wiped as completely as possible.

According to a further advantageous refinement of the invention, the wiper bearing of the at least one windscreen wiper is arranged in such a way that an essentially parallel alignment of the windscreen wiper with respect to the respective A-column of the vehicle is achieved in an upper wiper end position. This ensures that the remaining edge region in which wiping is not possible is reduced to the greatest extent possible.

According to a further advantageous refinement of the invention, a passenger-side wiper shaft is driven via a transmission rod which is connected to a driver-side crank. The drive rod assembly thus has just a single rod which extends in the direction of travel, and thus requires less space than if both wiper shafts were to be driven via respective drive rods in the direction of travel.

According to an alternative refinement of the invention, two wiper shafts are directly driven by the motor via respective rod assemblies. The necessary drive power of the motor and the direct stressing of the respective windscreen wiper is more favourable in this case.

According to a further advantageous refinement of the invention, a mounted deflector or transmission disc is provided, via which the wiper shaft is indirectly driven. The relative arrangement of the wiper motor and of the rod is thus more variable. A space-optimized arrangement and design of the wiper system is thus possible.

According to a further advantageous refinement of the invention, the motor of the wiper system is arranged approximately in the centre between a driver-side wiper bearing and a passenger-side wiper bearing. The introduction of force into the wiper shafts via respective rod parts is better in this case than in the case where in the direction of travel an essentially parallel arrangement of the wiper motor with respect to one or the other wiper bearing is selected.

Further advantages and features of the invention can be found in the following description in which the invention is described and explained in more detail with reference to the examples of embodiments shown in the drawing.

In the drawing:

FIG. 1 shows a plan view of a wiper system according to the prior art;

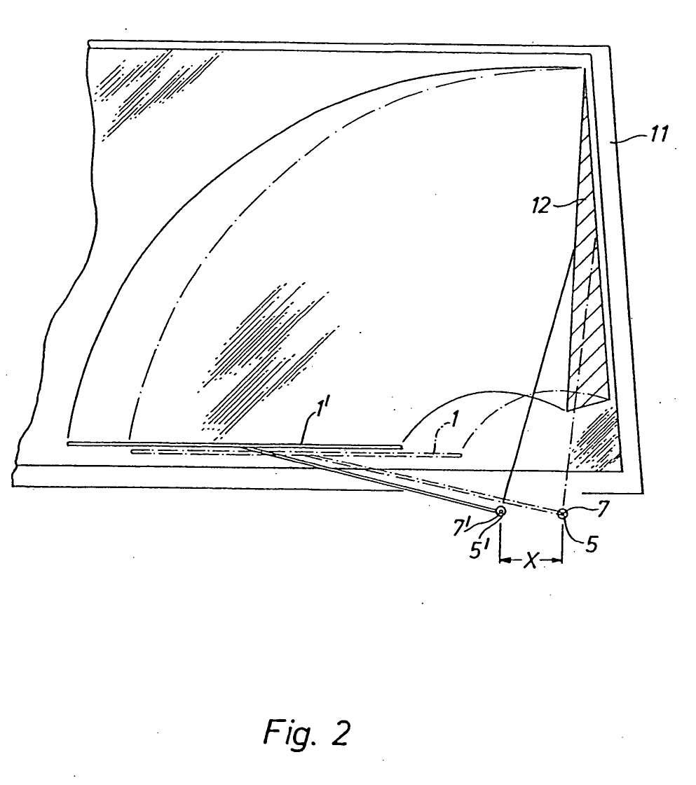

FIG. 2 shows a schematic plan view of a comparison of a driver-side wiping area of a wiper system according to the prior art and according to the invention;

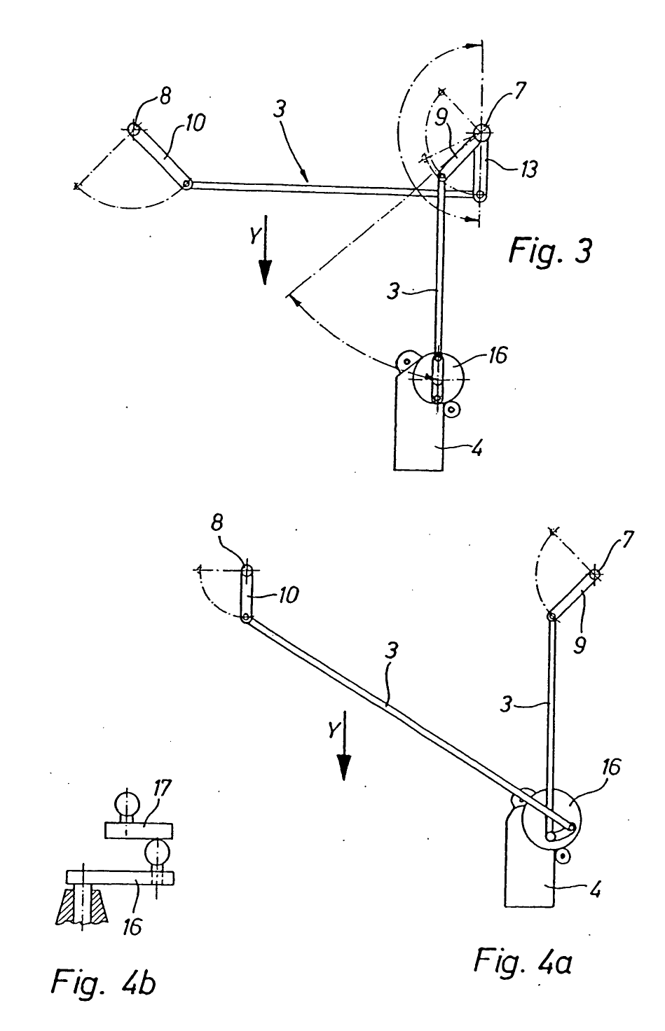

FIG. 3 shows a schematic plan view of a first example of embodiment of a wiper system according to the invention;

FIG. 4a shows a schematic plan view of a second example of embodiment of a wiper system according to the invention;

FIG. 4b shows a detailed view of part of the transmission rod of the example of embodiment of FIG. 4a in a cut-away side view;

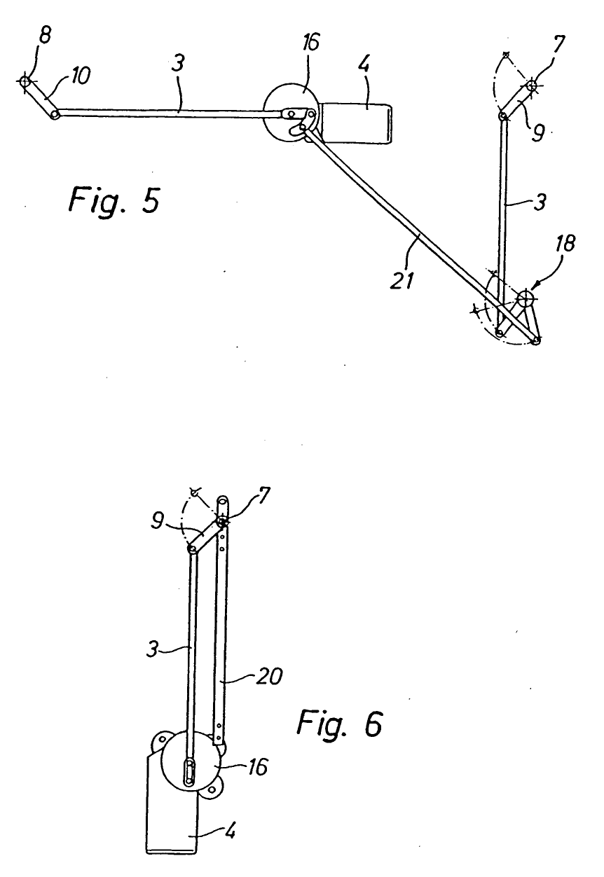

FIG. 5 shows a plan view of a third example of embodiment of a wiper system according to the invention;

FIG. 6 shows a partial plan view of a fourth example of embodiment of a wiper system according to the invention.

From FIG. 1 it can be seen how an arrangement of elements of a wiper system in the prior art has been achieved to date. A motor 4 is located essentially between two wiper bearings 5, 6, which it actuates via a drive rod 3 and deflectors 14 for producing the reversing wiping movement of windscreen wipers (not shown). The two wiper bearings 5, 6 are rigidly spaced apart from one another via a connecting frame 19. On account of this arrangement of the motor 4 and of the drive rod 3 essentially between the two wiper shafts 7, 8, it is necessary, both in systems which operate in the same direction and in systems which operate in opposite directions, that deflectors 14 are provided which protrude outwards at least on the driver side. In the example shown in FIG. 1, a deflector 14 protrudes laterally outwards from the wiper shaft 7 or the bearing 5 by an amount X in the parked position of the wiper system. In conventional vehicles, it is therefore not possible to realize an approximately parallel arrangement of the wiper blade with respect to the respective A-column.

This is shown by the schematic diagram of a windscreen wiper system according to the prior art compared to a windscreen wiper system according to the invention on the driver side of a vehicle in FIG. 2. According to the invention, the motor and the drive rod are arranged and designed in such a way that an outwardly protruding deflection rod or crank is not necessary. As a result, in particular the driver-side wiper bearing 5 and the corresponding wiper shaft 7 can be arranged an amount X closer to the outer side of the vehicle or to the A-column 11, as a result of which an additional wiping area 12 can be wiped on account of the approximately parallel alignment of the windscreen wiper 1 with respect to the A-column 11.

A first example of embodiment of a wiper system according to the invention is shown schematically in FIG. 3. In this example of embodiment, the wiper motor 4 is arranged in front of the two wiper shafts 7, 8 in the direction of travel Y of the vehicle and is connected to said shafts via an additional transmission crank 13 and a transmission disc 16. The driver-side crank 9, which is connected to the wiper shaft 7 and carries out a back-and-forth movement during operation of the wiper system, can as a result be oriented in the direction of the vehicle centre, that is to say a direction which points towards the other wiper shaft 8. As a result, the wiper shaft 7 can be arranged very close to the A-column (not shown) of the vehicle, since a pivoting space on the right-hand side of the wiper shaft 7 (outer side) is not necessary. As a result, a larger area of the vehicle windscreen can be wiped (cf. area 12 in FIG. 2).

A second example of embodiment of a wiper system is shown schematically in a plan view in FIG. 4a and in the detail in FIG. 4b. Compared to the previous example of embodiment, in this case each wiper shaft 7, 8 is driven directly by means of a transmission rod 3 via a transmission disc 16, and not just the driver-side wiper shaft 7. For this reason, the transmission disc 16, which is fixed on the motor 4 and is driven by the latter, is connected to an eccentric disc 17. The eccentric disc 17 has a smaller diameter than the transmission disc 16. The diameter may however be the same; the critical thing is that the wipers are located in the stretched position and in the parked position at the same time. The motor 4 is arranged in front of the two wiper shafts 7, 8 in the direction of travel Y, so that in particular the driver-side crank 9 only protrudes inwards in each pivoting position so that an additional area close to the A-column of the vehicle can be wiped in the case of a wiper system which operates in the same direction.

FIG. 5 shows a further example of embodiment according to the invention in a simplified plan view. Compared to the previous examples of embodiments, although the motor 4 is arranged between the two wiper shafts 7, 8, the arrangement here is nevertheless also selected, via a transmission disc 16 and a deflection mechanism 18 and an intermediate rod 21, in such a way that the driver-side and passenger-side cranks 9, 10 in each case protrude only inwards in each pivoting position. This drive system also allows the wiper shafts 7, 8 to be arranged closer to the respective A-columns, in this case both in a wiper system which operates in the same direction and in a wiper system which operates in opposite directions.

FIG. 6 shows a fourth example of embodiment of a wiper system according to the invention. In this example of embodiment, the two wiper bearings are driven by a separate motor 4 (only one side is shown). A transmission disc 16 drives the crank 9 on the wiper bearing 7 via deflection bearings and a drive rod 3. The counter-moment is absorbed by a retaining tube 20 between the bearing 7 and the motor 4. A corresponding drive unit is provided for the second wiper bearing (not shown). This embodiment is suitable both for wiper systems which operate in opposite directions and for wiper systems which operate in the same direction.

Of course, the invention can be applied to different wiper systems, e.g. systems which have one, two or even more than two windscreen wipers. The wiper systems may be operated in opposite directions or in the same direction.

All of the features shown in the description, the following claims and the drawing may be essential to the invention both individually and also in any combination with one another.

### LIST OF REFERENCES

1, 2 windscreen wiper
3 drive rod
4 motor
5, 6 wiper bearing
7, 8 wiper shaft
9, 10 drive crank
11 A-column
12 additional wiping area
13 transmission crank
14 deflector (prior art)
15 retaining plate
16 transmission disc
17 eccentric disc
18 deflection mechanism
19 connecting tube
20 retaining tube
21 intermediate rod
X offset distance invention/prior art
Y direction of travel of vehicle

1. Wiper system for a windscreen of a vehicle, in particular of a motor vehicle, comprising two simultaneously driven windscreen wipers and comprising a drive rod between a motor and a wiper bearing of a wiper shaft characterized in that the motor and the drive rod are arranged and designed in such a way that at least a driver-side crank can be provided for driving the said wiper shaft which crank in each position is oriented in a direction towards the vehicle center.

2. Wiper system according to claim 1, characterized in that the said driver-side crank and the a passenger-side crank can be provided for driving the wiper shafts which cranks in each pivoting position are oriented towards the vehicle center.

3. Wiper system according to claim 1, characterized in that the motor is arranged in front of and at a distance from said wiper bearing in the direction of travel (Y) of the vehicle.

4. Wiper system according to claim 2, characterized in that the motor is connected to a driver-side wiper bearing via the drive rod.

5. Wiper system according to claim 1, characterized in that at least said driver-side wiper bearing is arranged close to an A-column of the vehicle.

6. Wiper system according to claim 1, characterized in that said wiper bearings are arranged in such a way that an essentially parallel alignment of the at least one windscreen wiper with respect to the respective vehicle column of the vehicle is achieved in an upper wiper end position.

7. Wiper system according to claim, characterized in that a passenger-side wiper shaft is driven via a transmission rod which is indirectly connected to the motor by a driver-side crank.

8. Wiper system according to claim, characterized in that two wiper shafts are directly driven by the motor via respective rod assemblies.

9. Wiper system according to claim 1, characterized in that a mounted deflector or a transmission disc is provided, via which the wiper shaft is indirectly driven.

10. Wiper system according to claim 9, characterized in that the motor is arranged approximately in the center between a driver-side wiper bearing and a passenger-side wiper bearing.

11. Wiper system according to claim 1, characterized in that it is a wiper system which operates in opposite directions.

12. Drive unit for a wiper system of a vehicle, in particular for a wiper system according to claim 1, characterized in that a said drive rod and a said motor are arranged and designed in such a way that said at least a driver-side crank can be provided for driving a wiper shaft, which crank in each position is oriented in a direction towards the vehicle center.

13. Drive unit according to claim 12, characterized in that the motor is arranged in front of and at a distance from the wiper bearing in the direction of travel (Y) of the vehicle.

14. A wiper system for use on a vehicle having a windscreen and an associated A-column, said wiper system comprising:
a motor for driving a first windshield wiper coupled to a first bearing and a second windshield wiper coupled to a second bearing;
a drive rod for coupling said motor to said first and second bearings; and
at least one crank for coupling at least one of said first bearing or said second bearing to said drive rod;
said drive rod, said motor and said at least one crank being situated generally between said first and second bearings at all times during wiping and permitting at least one of said first or second windshield wipers to become situated generally parallel to said A-column during wiping.

15. The wiper system as recited in claim 14 wherein said at least one crank is oriented towards a center of the vehicle and between said first and second bearings.

16. The wiper system as recited in claim 14 wherein said motor is situated in a vehicle direction location of said first and second windshield wipers.

17. The wiper system as recited in claim 14 wherein said first windshield wiper is associated with a driver's side of said vehicle, said at least one crank being situated toward a center of said vehicle and generally between said first and second bearings when said first windshield wiper is generally parallel to said A-frame of said vehicle.

18. The wiper system as recited in claim 14 wherein said motor is situated between said drive arm and a front of said vehicle.

19. The wiper system as recited in claim 14 wherein said drive arm comprises a first drive arm having a first end coupled to said first bearing and a second end coupled to said motor and also comprising a second drive arm having a first end coupled to said second bearing and said second end also coupled to said motor.

20. The wiper system as recited in claim 14 wherein said drive motor, drive arm and at least one link are coupled together and cooperate to drive said first and second windshield wiper blades in opposite directions.

21. The wiper system as recited in claim 14 wherein said system comprises an intermediate drive rod having one end driven by said motor; a transmission disc coupled to another end of said intermediate drive rod; said drive rod comprising a first drive rod having a first end coupled to said transmission member and a second end coupled to a first link coupled to said first bearing, said first drive rod being responsive to said first transmission disc to drive said first windshield wiper blade in response to said motor driving said intermediate drive rod which, in turn, drives said transmission disc; each of said intermediate drive arm, said link and said first drive arm being situated between said first and second bearings even when said first windshield wiper blade is generally parallel to said A-column.

22. A windshield wiper system for driving a first windshield wiper blade and a second windshield wiper blade in a vehicle comprising a driver's side frame and a passenger side frame, said windshield wiper system comprising:
a first bearing coupled to said first windshield wiper blade;
a second bearing coupled to said second wiper blade;
drive linkage coupling said first and second bearings to a motor in order to permit at least one of said first or second wiper blades to become generally parallel to said driver's side frame or said passenger side frame, respectively.

23. The windshield wiper system as recited in claim 22 wherein said drive linkage is situated generally between said first and second bearings at all times during wiping.

24. The windshield wiper system as recited in claim 22 wherein said drive linkage comprises at least one crank oriented towards a center of the vehicle and between said first and second bearings.

25. The windshield wiper system as recited in claim 22 wherein said motor is situated between said drive linkage and a front of said vehicle in vehicle direction location.

26. The windshield wiper system as recited in claim 22 wherein said first windshield wiper is associated with said driver's side of said vehicle, said drive linkage comprising at least one crank situated toward a center of said vehicle and generally between said first and second bearings when said first windshield wiper is generally parallel to said driver's side frame of said vehicle.

27. The windshield wiper system as recited in claim 26 wherein said second windshield wiper is associated with said passenger's side of said vehicle, said drive linkage comprising at least one second crank coupled to said second bearing and situated toward a center of said vehicle and generally between said first and second bearings when said second windshield wiper is generally parallel to said passenger's side frame of said vehicle.

28. The windshield wiper system as recited in claim 14 wherein said drive linkage comprises a drive arm coupled to said motor, said motor being situated between said drive arm and a front of said vehicle.
